(19) United States
(12) Patent Application Publication
(10) Pub. No.: US 2026/0052215 A1
(43) Pub. Date: Feb. 19, 2026

(54) INSPECTION APPARATUS

(71) Applicant: CANON KABUSHIKI KAISHA, Tokyo (JP)

(72) Inventor: YOSUKE KAGAWA, Chiba (JP)

(21) Appl. No.: 19/290,496

(22) Filed: Aug. 5, 2025

(30) Foreign Application Priority Data
Aug. 13, 2024 (JP) 2024-135033

(51) Int. Cl. H04N 1/00

(52) U.S. Cl. CPC H04N 1/00076; H04N 1/00005; H04N 1/00015; H04N 1/00037; H04N 1/00082

(57) ABSTRACT

An inspection apparatus performs inspection on an image formed on a sheet, based on an inspection image obtained by reading the sheet. The inspection apparatus includes a display unit, and a control unit configured to, in a case where an abnormal image is included in an inspection result, display, on the display unit, a confirmation screen including a first display area in which an image showing the inspection result including the abnormal image is displayed, and a second display area in which an enlarged image of the abnormal image in the inspection result is displayed. The control unit adjusts a size of the first display area and a size of the second display area in the confirmation screen in accordance with a size of the inspection image.

### BACKGROUND

### Field of the Technology

The present disclosure relates to an inspection apparatus that inspects the quality of an image formed on a sheet.

### Description of the Related Art

In some image forming systems, an inspection apparatus inspects the quality of an image formed on a sheet by an image forming apparatus. The inspection apparatus performs inspection based on a read image (inspection image) obtained by reading an image formed on a sheet. The image forming system presents the inspection result obtained by the inspection apparatus to a user by, for example, displaying the inspection result on a display device.

Japanese Patent Laid-Open No. 2021-27582 describes displaying, in one screen, a print job including a page having an abnormality, inspection result information indicating, for example, the type of abnormality (defect) present on the page, and a preview image or a thumbnail image of the page that has the abnormality. Japanese Patent Laid-Open No. 2022-140540 describes that an area including an abnormality in a read image and an area corresponding to the abnormality in a normal image are each enlarged and displayed in an inspection result report display screen. Displaying the inspection result in such ways can make it easier for the user to grasp the location of an abnormality.

There is room for further improvement in a method for displaying an inspection result display screen.

### SUMMARY

According to one aspect of the present disclosure, there is provided an inspection apparatus that performs inspection on an image formed on a sheet, based on an inspection image obtained by reading the sheet, the inspection apparatus comprising: a display unit;

and a control unit configured to, in a case where an abnormal image is included in an inspection result, display, on the display unit, a confirmation screen including a first display area in which an image showing the inspection result including the abnormal image is displayed, and a second display area in which an enlarged image of the abnormal image in the inspection result is displayed, wherein the control unit adjusts a size of the first display area and a size of the second display area in the confirmation screen in accordance with a size of the inspection image.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a cross-sectional view showing an example of the hardware configuration of an image forming system.

FIG. 2 is a block diagram showing an example of the configuration of a control apparatus.

FIG. 3 is a block diagram showing an example of the configuration of an inspection apparatus.

FIG. 4 is a block diagram showing an example of the configuration of a stacking apparatus.

FIG. 5 is a flowchart showing an example of a processing procedure performed by the control apparatus.

FIG. 6 is a flowchart showing an example of a processing procedure performed by the inspection apparatus.

FIG. 7 shows an example of a print setting screen.

FIG. 8 shows an example of an inspection setting screen.

FIG. 9 shows an example of the inspection result screen.

FIG. 10 shows an example of the inspection result screen.

FIG. 11A is a flowchart showing an example of inspection result display processing.

FIG. 11B is a flowchart showing an example of magnification rate change processing.

FIG. 12 shows an example of the inspection result screen (comparative example).

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

In recent years, in addition to standard size sheets such as A4 and B5, various types of sheets such as long-sized sheets (long paper), which are long in the conveying direction, and free size sheets have become the subject of inspection by an inspection apparatus. For example, when the entirety of an inspection image of a long-sized sheet is displayed in a fixed display area in an inspection result display screen (confirmation screen), a large blank area may appear in the display area due to the size of the sheet. As a result, the amount of area available for displaying information regarding the inspection result in the confirmation screen becomes limited, which may result in the user needing to spend time and effort when checking the inspection result. In view of this, embodiments of the present disclosure provide a technique for making it easier for an inspection result to be checked by a user.

### <Image Forming System>

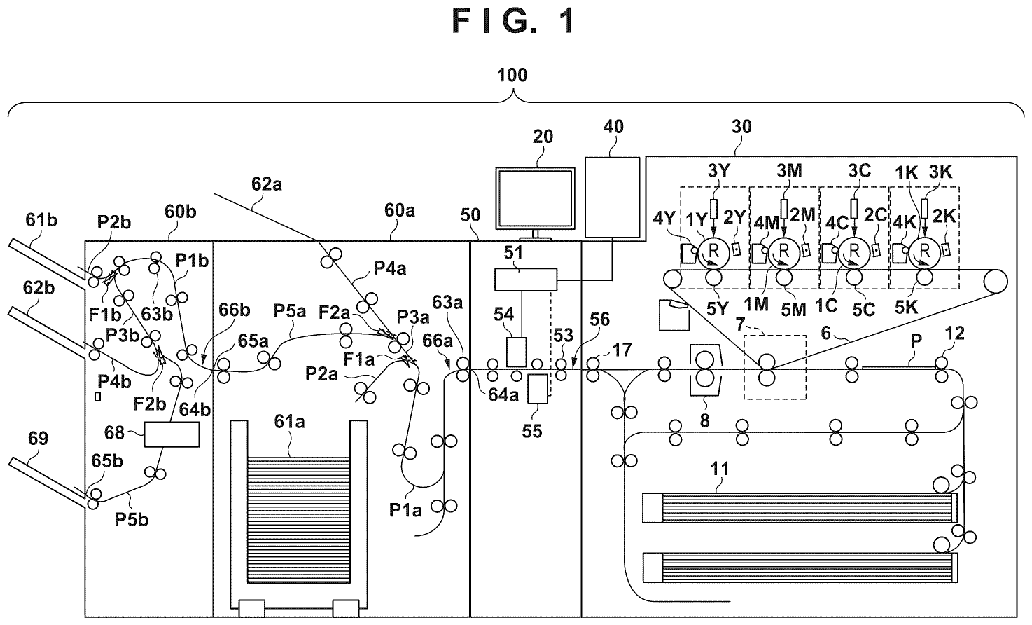

As shown in FIG. 1, an image forming system 100 includes an operation unit 20, an image forming apparatus 30, a control apparatus 40, an inspection apparatus 50, and stacking apparatuses 60a and 60b. The image forming apparatus 30, the inspection apparatus 50, and the stacking apparatuses 60a and 60b each have a separate housing. The number of stacking apparatuses 60 may be one or more. The image forming system 100 may also be referred to as an image inspection system. In this example, the stacking apparatus 60a may be called a sheet stacker or a sheet conveying apparatus. The stacking apparatus 60b may be called a post-processing apparatus having a post-processing function, or a finisher. Identical or similar components are denoted by the same reference numbers, and the final lowercase letter (e.g., “a” or “b”) may be omitted when describing matters common to these components.

The operation unit 20 has a display device for outputting information to the user, and an input device (e.g., a touch panel sensor) for receiving instructions from the user.

The image forming apparatus 30 forms a toner image on a sheet P in accordance with YMCK color signals supplied by the control apparatus 40. The letters “YMCK” appended to the reference signs represent the toner colors yellow, magenta, cyan, and black, respectively. The letters YMCK will be omitted from the reference numbers when describing matter common to all four colors.

For each of the colors, a photosensitive member 1 is an image carrier that carries an electrostatic latent image and a toner image. A charger 2 charges the surface of the photosensitive member 1 uniformly. An exposure unit 3 forms an electrostatic latent image on the photosensitive member 1 by irradiating it with laser light that conforms to a color signal supplied by the control apparatus 40. A developing unit 4 develops the electrostatic latent image with toner to form a toner image. A primary transfer roller 5 transfers the toner image from the photosensitive member 1 to an intermediate transfer belt 6. YMCK toner images are superimposed on the intermediate transfer belt 6 to form a color image. The intermediate transfer belt 6 transports the resulting toner image to a secondary transfer unit 7.

Sheet cassettes 11 are containers for storing large numbers of sheets P. Conveying rollers 12 feed the sheets P stored in the sheet cassettes 11 and convey the fed sheets P along a conveying path. The image forming apparatus 30 may have two or more sheet cassettes.

The secondary transfer unit 7 transfers the toner image from the intermediate transfer belt 6 to a sheet P. A fuser 8 applies heat and pressure to the sheet P and the toner image to fuse the toner image onto the sheet P. Discharge rollers 17 discharge the sheet P to the inspection apparatus 50.

The inspection apparatus 50 is an apparatus that reads the image formed on the sheet P and inspects the quality of the image. In other words, the inspection apparatus 50 is an apparatus that inspects whether or not the image formed on the sheet P meets an inspection standard (acceptance standard). Note that the sheet P on which the image is formed is sometimes called a printed material. The inspection apparatus 50 obtains an inspection image by reading the printed material, which includes the sheet P and the image formed on the sheet P by the image forming apparatus 30, and performs inspection on the printed material based on the inspection image.

The image on the sheet P being conveyed to a reading position by conveying rollers 53 is read by image sensors 54 and 55. The image sensors 54 and 55 each include a light source that illuminates the sheet P and a CMOS sensor. CMOS is an abbreviation for Complementary Metal-Oxide Semiconductor.

The sheet P from which the image has been read is discharged to the stacking apparatus 60a. Note that when the inspection apparatus 50 determines that a sheet P has failed the inspection (i.e., the inspection standard has not been met, which will also be called “unacceptable”), the control apparatus 40 may control the image forming apparatus 30 so as to form the same image on a new sheet P. A sheet sensor 56 for detecting the sheet P is provided at the entrance of the inspection apparatus 50.

The stacking apparatus 60a receives sheets P discharged from the inspection apparatus 50 at an entrance 64a, stacks (discharges) the sheets onto a sheet tray 61a or a sheet tray 62a serving as stacking units, and discharges the sheet P from an exit 65a. A sheet sensor 66a for detecting a sheet P is provided at the entrance 64a.

A conveying path Pla extending from the entrance 64a branches into a conveying path P2a and a conveying path P3a at a branching position where a flapper Fla is provided. A sheet P conveyed along the conveying path Pla is guided by the flapper Fla to the conveying path P2a or the conveying path P3a. The sheet tray 61a is provided at the exit of the conveying path P2a. The sheet tray 61a is a large-capacity sheet stacking unit in which a large number of sheets P can be stacked. For example, sheets P that have been determined to have passed image inspection (quality inspection) may be stacked in the sheet tray 61a.

The conveying path P3a branches into a conveying path P4a and a conveying path P5a at a branching position where a flapper F2a is provided. A sheet P conveyed along the conveying path P3a is guided by the flapper F2a to the conveying path P4a or the conveying path P5a.

The sheet tray 62a is provided at the exit of the conveying path P4a. For example, sheets P for which the image quality has been determined to be unacceptable by the inspection apparatus 50 may be stacked in the sheet tray 62a. However, sheets P for which the image quality has been determined to be unacceptable may be discharged from the exit 65a to a downstream device (e.g., the stacking apparatus 60c). Also, sheets P determined to have passed the inspection (i.e., the inspection standard has been met, which will also be called “acceptable”) may be stacked in the sheet tray 62a. The conveying path P5a extends to the exit 65a.

The downstream stacking apparatus 60b may be connected to the exit 65a. Also, similarly to the stacking apparatus 60b, a sheet tray 69 may be provided at the exit 65a. The sheet tray 69 can also hold sheets P for which the image quality has been determined to be unacceptable or sheets P for which the image quality has been determined to be acceptable. In this way, the type of sheets P that are to be discharged onto the sheet trays 61a, 61b, 62a, 62b, and 69 is determined in advance based on setting performed by the user.

One or more conveying rollers 63a are provided for each of the conveying paths Pla, P2a, P3a, P4a, and P5a. The conveying rollers 63a convey a sheet P from the upstream side to the downstream side in the conveying direction of the sheet P. The conveying rollers 63a may be a roller pair including two rollers that nip and convey the sheet P.

The stacking apparatus 60b receives sheets P discharged from the stacking apparatus 60a at an entrance 64b, and stacks (discharges) the sheets onto sheet trays 61b, 62b, and 69 serving as stacking units. A sheet sensor 66b for detecting a sheet P is provided at the entrance 64b.

A conveying path P1b extending from the entrance 64b branches into a conveying path P2b and a conveying path P3b at a branching position where a flapper F1b is provided. A sheet P conveyed along the conveying path P1b is guided by the flapper F1b to the conveying path P2b or the conveying path P3b. The sheet tray 61b is provided at the exit of the conveying path P2b. For example, sheets P that have been determined to have passed image inspection (quality inspection) may be stacked in the sheet tray 61b.

The conveying path P3b branches into a conveying path P4b and a conveying path P5b at a branching position where a flapper F2b is provided. A sheet P conveyed along the conveying path P3b is guided by the flapper F2b to the conveying path P4b or the conveying path P5b.

The sheet tray 62b is provided at the exit of the conveying path P4b. For example, sheets P for which the image quality has been determined to be unacceptable by the inspection apparatus 50 may be stacked in the sheet tray 62b. However, sheets P for which the image quality has been determined to be unacceptable may be discharged from the exit 65b to the sheet tray 69. Also, sheets P determined to have passed the inspection (i.e., the inspection standard has been met, which will also be called “acceptable”) may be stacked in the sheet tray 62b. The conveying path P5b extends through a post-processing unit 68 and reaches the exit 65b.

The sheet trays 61b, 62b, and 69 provided in the stacking apparatus 60b may be referred to as an upper tray, a middle tray, and a lower tray, respectively. The post-processing unit 68 may include a binding processor that binds the sheets P discharged from the stacking apparatus 60a to create a sheet bundle, and then binds the sheet bundle with staples. The post-processing unit 68 may include a bookbinding processor that folds the sheet bundle in half. The post-processing unit 68 may include a cutting processor that cuts the sheet bundle.

One or more conveying rollers 63b are provided for each of the conveying paths P1b, P2b, P3b, P4b, and P5b. The conveying rollers 63b convey a sheet P from the upstream side to the downstream side in the conveying direction of the sheet P. The conveying rollers 63b may be a roller pair including two rollers that nip and convey the sheet P.

The number of stacking apparatuses 60 connected downstream of the inspection apparatus 50 may be one or more. Furthermore, the total number of sheet trays 61, 62, and 69 provided in a stacking apparatus 60 connected downstream of the inspection apparatus 50 may be two or more. Moreover, the number of flappers F1 and F2 may be one or more. The flappers F1 and F2 may be called guide plates, guide members, or bifurcating claws. Note that the image forming apparatus 30 also includes solenoids for driving the flappers and motors for driving the conveying rollers, but these components are not shown.

### <Control Apparatus (Controller)>

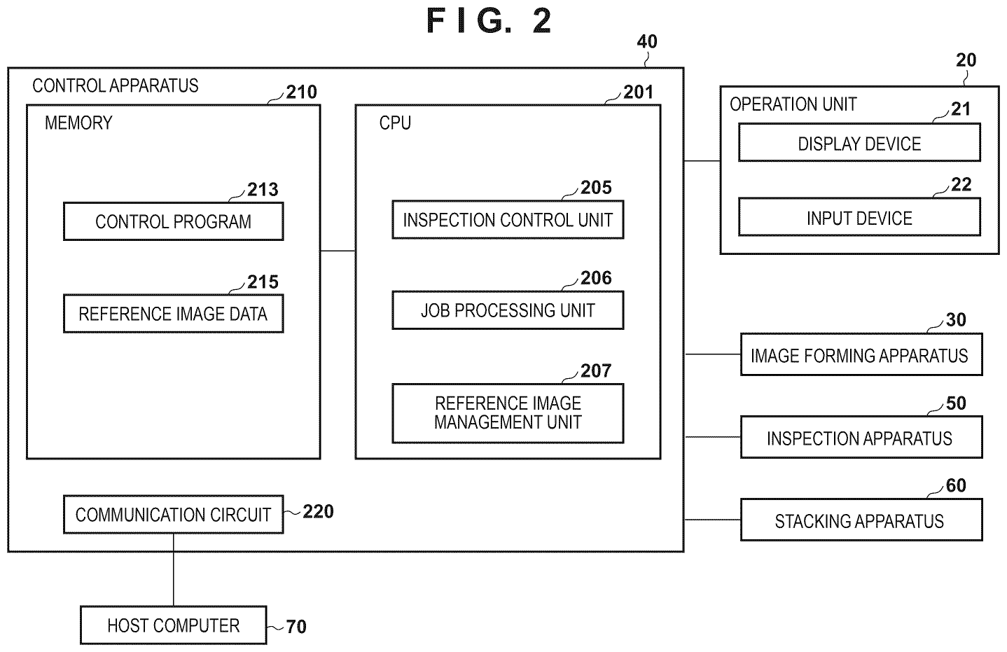

FIG. 2 shows an example of the configuration of the control apparatus 40. The control apparatus 40 includes a CPU 201, a memory 210, and a communication circuit 220. The CPU 201 executes a control program 213 stored in the memory 210 to realize various functions. The CPU 201 may include multiple processors or CPU cores. Some or all of the functions implemented by the CPU 201 may be implemented by a hardware circuit different from the CPU 201. Examples of such hardware circuits include, for example, application specific integrated circuits (ASICs), field programmable gate arrays (FPGAs), and image processors.

The memory 210 is a storage device that includes a read-only memory (ROM), a random access memory (RAM), a solid-state drive (SSD), a hard disk drive (HDD), or the like. The communication circuit 220 has a network interface for connecting to a local area network, and a communication interface for communicating with the image forming apparatus 30, the inspection apparatus 50, and the stacking apparatus 60.

The CPU 201 performs communication with the image forming apparatus 30, the inspection apparatus 50, and the stacking apparatus 60 through the communication circuit 220. Furthermore, the CPU 201 performs communication with a host computer 70, which is a type of information processing device, through the communication circuit 220. The host computer 70 may transmit print jobs to the control apparatus 40.

The operation unit 20 includes the display device 21 and the input device 22. The operation unit 20 may include a voice circuit and a speaker for outputting messages to the user.

The CPU 201 functions as an inspection control unit 205, a job processing unit 206, and a reference image management unit 207 in accordance with the control program 213. The inspection control unit 205 obtains image inspection result information (e.g., pass/fail, read image, cause of failure) from the inspection apparatus 50 via the communication circuit 220. The inspection control unit 205 displays the inspection result received from the inspection apparatus 50 on the display device 21. The inspection control unit 205 may notify the inspection result using a voice message. The inspection control unit 205 may transmit the inspection result to the host computer 70 by email or the like. The inspection control unit 205 may change the discharge destination of a sheet P in accordance with the inspection result. For example, the inspection control unit 205 may control the flappers F1 and F2 based on the inspection result to discharge a sheet P to a sheet tray designated by the user from among the sheet trays 61, 62, and 69.

The job processing unit 206 performs control regarding, for example, a print job for printing an image on a sheet P, a stacking job for stacking a sheet bundle on the stacking apparatus 60a, and a post-processing job for a sheet bundle in the stacking apparatus 60b. The job processing unit 206 may store job data (job information) required to execute such jobs in the memory 210.

The reference image management unit 207 controls the inspection apparatus 50 in accordance with instructions received from the input device 22, and generates reference image data 215. Here, the reference image is an image that is compared with a read image (inspection image) of a printed material, and serves as a reference for determining whether image inspection has been passed. The reference image management unit 207 generates the reference image data 215 based on, for example, input image data received from the host computer 70, or reads a printed material (a sheet P on which a reference image is printed) to generate the reference image data 215. The reference image management unit 207 stores the generated reference image data 215 in the memory 210. Upon receiving a reference image request from the inspection apparatus 50 via the communication circuit 220, the reference image management unit 207 transmits the reference image data 215 from the memory 210 to the inspection apparatus 50.

### <Inspection Apparatus>

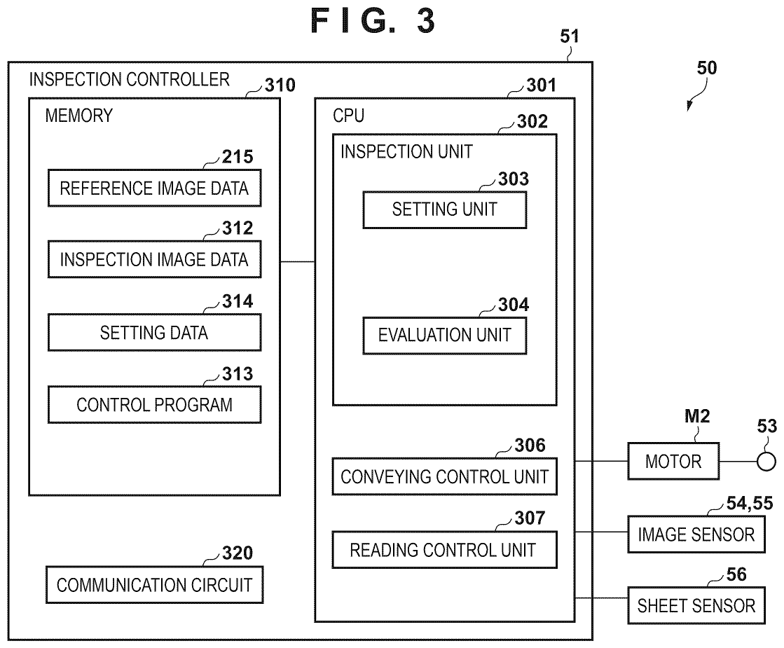

FIG. 3 shows an example of the configuration of the inspection apparatus 50, which includes an inspection controller 51. The inspection controller 51 includes a CPU 301, a memory 310, and a communication circuit 320. The CPU 301 executes a control program 313 stored in the memory 310 to realize various functions. Some or all of the functions implemented by the CPU 301 may be implemented by a hardware circuit different from the CPU 301.

The memory 310 is a storage device that includes a ROM, a RAM, an SSD, an HDD, or the like. The CPU 301 is connected to the control apparatus 40 via a communication circuit 320, and receives various types of commands and data and transmits inspection results. The CPU 301 stores the reference image data 215 received from the control apparatus 40 via the communication circuit 320 in the memory 310.

The CPU 301 functions as an inspection unit 302, a conveying control unit 306, and a reading control unit 307 in accordance with the control program 313. The inspection unit 302 includes a setting unit 303 and an evaluation unit 304. The inspection unit 302 executes image inspection in accordance with setting data 314 stored in the memory 310, and transmits inspection results to the control apparatus 40. Note that inspection may be executed by the CPU 201 or may be executed by an external PC (e.g., the host computer 70) connected to the image forming system 100. PC is an abbreviation for personal computer.

Inspection image data (read image data) 312 is image data created by the image sensors 54 and 55 reading a sheet P. The inspection image data 312 is also temporarily stored in the memory 310.

The setting unit 303 determines inspection settings to be applied to the inspection image data 312, creates the setting data 314 that defines the inspection settings, and stores the setting data 314 in the memory 310.

The evaluation unit 304 determines whether the leading edge of a sheet P has reached the inspection apparatus 50 based on the detection result of the sheet sensor 56. When a sheet P reaches the inspection apparatus 50, the evaluation unit 304 controls the image sensors 54 and 55 via the reading control unit 307 to read the sheet P and obtain the inspection image data 312. The evaluation unit 304 compares the reference image data 215 with the inspection image data 312 based on the setting data 314, and determines whether the image formed on the sheet P and the shape of the sheet P meet the inspection standard. Here, the inspection content, the inspection area, and the inspection standard may be included in the setting data 314.

For example, when the inspection content is “detection of positional deviation”, the evaluation unit 304 may determine that the inspection has been passed if the amount of deviation between the position of the image corresponding to the reference image data 215 and the position of the image corresponding to the inspection image data 312 is less than or equal to a predetermined value. Here, the position of the image refers to the position of the image formed on the sheet P. If the amount of deviation exceeds the predetermined value, the evaluation unit 304 may determine that the sheet P failed the inspection. In other words, if the amount of deviation between the position of the image corresponding to the reference image data 215 and the position of the image corresponding to the inspection image data 312 is less than or equal to the predetermined value, this corresponds to meeting the inspection standard. If the amount of deviation between the position of the image corresponding to the reference image data 215 and the position of the image corresponding to the inspection image data 312 that is greater than the predetermined value, this corresponds to not meeting the inspection standard.

When the inspection content is set to “black spot detection”, the evaluation unit 304 may determine that the inspection has been passed if the size of a black spot that is not present in the image corresponding to the reference image data 215 and is present in the image of the inspection image data 312 is smaller than or equal to a determination threshold. In other words, the black dot corresponds to a noise image that is not present in the image corresponding to the reference image data 215 but is present in the image corresponding to the inspection image data 312 that has been subjected to reduction processing. The evaluation unit 304 may determine that the inspection has not been passed if the size of the black dot exceeds the determination threshold. In other words, if the size of the black dot does not exceed the determination threshold, this corresponds to meeting the inspection standard. Moreover, if the size of the black dot exceeds the determination threshold, this corresponds to not meeting the inspection standard.

Note that in the present embodiment, “detection of positional deviation” and “black spot detection” are described as inspection content, but these are merely examples. For example, the inspection content may include “streak detection” and the like. Streak detection refers to the detection of streak-like images that are not present in the original image. In other words, a streak corresponds to a noise image that is not present in the image corresponding to the reference image data 215 but is present in the image corresponding to the inspection image data 312 that has been subjected to reduction processing. Streaks can occur when parts involved in image formation require cleaning, replacement, or repair. In other words, determination processing may be performed to determine the presence or absence of streaks based on the degree of agreement between the image corresponding to the reference image data 215 and the image corresponding to the inspection image data 312 that has been subjected to reduction processing (image processing).

In the present embodiment, when the inspection content is “detection of positional deviation”, inspection is performed regarding the relative positions of the image corresponding to the reference image data 215 and the image corresponding to the inspection image data 312, but this is merely one example. For example, the absolute position of an edge of the sheet P in the image corresponding to the inspection image data 312 may be inspected. In this case, if the distance between the absolute position of the image corresponding to the reference image data 215 and the absolute position of the image corresponding to the inspection image data 312 is less than or equal to a threshold value, it is determined that the inspection has been passed. If the distance exceeds the threshold, it is determined that the inspection has been failed.

The evaluation unit 304 creates an inspection result indicating the determination result. The evaluation unit 304 transmits the inspection results to the control apparatus 40 via the communication circuit 320. In this way, the inspection unit 302 obtains the reference image data 215, which serves as the standard for inspecting a printed material, from the control apparatus 40, and obtains the inspection image data 312 by reading the printed material, which includes a sheet transported from the image forming apparatus 30 and an image formed on the sheet. The inspection unit 302 performs inspection on the printed material based on the reference image data 215 and the inspection image data 312.

The conveying control unit 306 drives a motor M2 to rotate the conveying rollers 53. The reading control unit 307 controls the image sensors 54 and 55 to read the sheet P and generate the inspection image data 312. The image sensor 54 reads a first side of the sheet P, and image sensor 55 reads a second side of the sheet P. As a result, in the present embodiment, image inspection can be executed on both sides of the sheet P.

### <Stacking Apparatus>

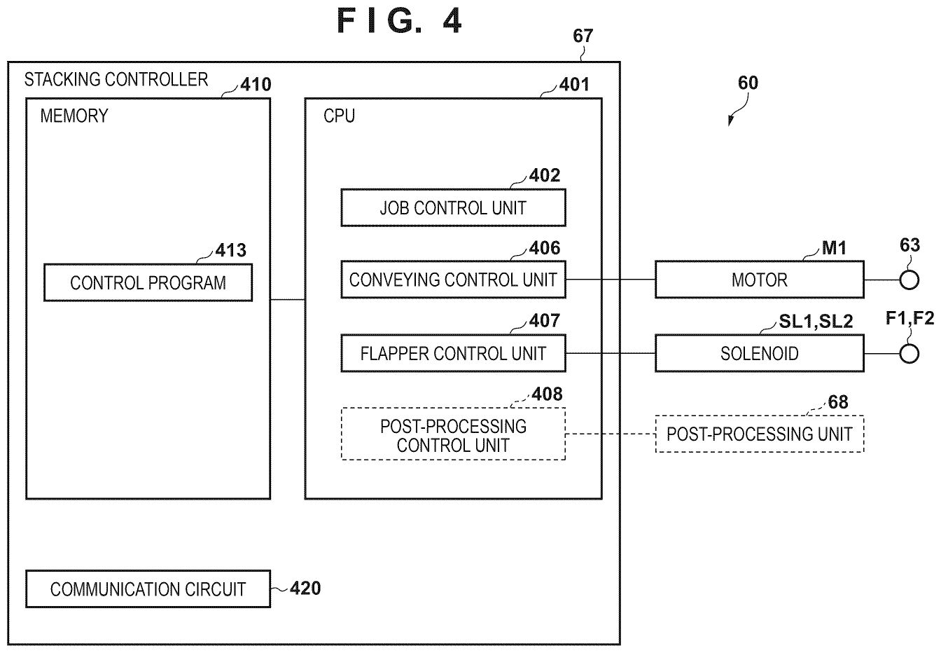

FIG. 4 shows an example of the configuration of one stacking apparatus 60, which includes a stacking controller 67. The stacking controller 67 includes a CPU 401, a memory 410, and a communication circuit 420. The CPU 401 executes a control program 413 stored in the memory 410 to realize various functions. Some or all of the functions implemented by the CPU 401 may be implemented by a hardware circuit different from the CPU 401.

The memory 410 is a storage device that includes a ROM, a RAM, an SSD, an HDD, or the like. The CPU 401 is connected to the control apparatus 40 via the communication circuit 420, and receives various types of commands and data and transmits execution results.

A job control unit 402 executes a stacking job based on job data (job information) received from the control apparatus 40 via the communication circuit 420. The job data may include, for example, information indicating the content of the job, and may be stored in the memory 410.

The conveying control unit 406 starts the rotation of a motor M1 in accordance with a rotation command received from the control apparatus 40 (job processing unit 206). The conveying control unit 406 stops the rotation of the motor M1 in accordance with a stop command received from the control apparatus 40 (job processing unit 206). As a result, the conveying rollers 63 driven by the motor M1 rotate and stop rotating.

A flapper control unit 407 drives solenoids SL1 and SL2 in accordance with a switching command received for each sheet P from the control apparatus 40 (job processing unit 206) to switch between the flappers F1 and F2. As a result, the discharge destination of each sheet P is determined (the sheet P is guided and transported to either the sheet tray 61, the sheet tray 62, or a downstream stacking apparatus). The flappers F1 and F2 may be controlled based on an inspection result received from the inspection apparatus 50 instead of the switching command received from the control apparatus 40. For example, the flappers F1 and F2 may be controlled such that a sheet P determined to have failed the inspection (unacceptable) is discharged to the sheet tray 62a of the stacking apparatus 60a, and a sheet P determined to have passed the inspection (acceptable) is discharged to the sheet tray 61a or the stacking apparatus 60b.

In FIG. 1, the stacking apparatus 60b is a post-processing apparatus, and includes a post-processing control unit 408. The post-processing control unit 408 controls the post-processing unit 68 in accordance with a post-processing execution command received from the control apparatus 40.

### <Processing Procedure of Control Apparatus 40>

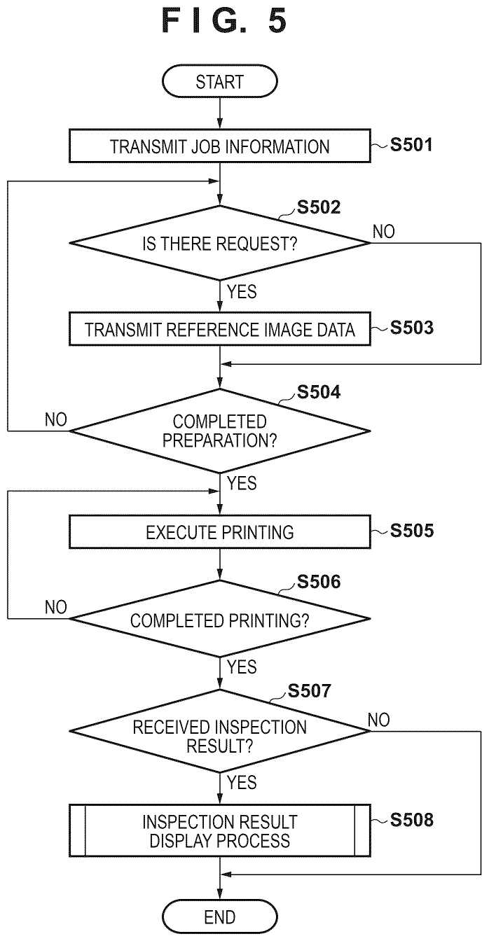

FIG. 5 is a flowchart showing an example of a procedure of processing executed by the CPU 201 of the control apparatus 40. When an instruction to start printing is received via the operation unit 20, the CPU 201 executes processing according to this procedure.

In step S501, the CPU 201 (job processing unit 206) creates job information for a print job and transmits the job information to the inspection apparatus 50. The job information includes sheet information, inspection settings, and discharge destination information, for example. The sheet information includes the size and number of sheets P. The job information may include, as part of the inspection settings, an instruction indicating that the inspection apparatus 50 is to execute an inspection job (i.e., information indicating that the print job is a job requiring image inspection to be performed on a sheet P). The discharge destination information can include, for example, identification information indicating whichever one of the stacking apparatuses 60a and 60b is to be the discharge destination, and identification information for a PASS tray and a FAIL tray. The PASS tray is a sheet tray onto which sheets P that have passed the image inspection performed by the inspection apparatus 50 (have been determined to be acceptable) are discharged. The FAIL tray is a sheet tray onto which sheets P that did not pass the image inspection performed by the inspection apparatus 50 (have been determined to be unacceptable) are discharged.

In step S502, the CPU 201 (inspection control unit 205) determines whether or not a request (reference image request) has been received from the inspection apparatus 50. This request is a signal for requesting the control apparatus 40 to transmit the reference image data 215. If the request has not been received, the CPU 201 moves to the processing of step S504. If the request has been received, the CPU 201 moves to the processing of step S503. In step S503, the CPU 201 (inspection control unit 205) reads out the reference image data 215 from the memory 210, transmits the read out data to the inspection apparatus 50, and moves to the processing of step S504. In this example, the reference image data 215 may be input image data used in image formation performed by the image forming apparatus 30.

In step S504, the CPU 201 (job processing unit 206) determines whether or not a notification of completion of preparation has been received from the inspection apparatus 50. If a notification of completion of preparation has not been received from the inspection apparatus 50, the CPU 201 returns to the processing of step S502. When a notification of completion of preparation is received from the inspection apparatus 50, the CPU 201 moves to the processing of step S505.

In step S505, the CPU 201 (job processing unit 206) controls the image forming apparatus 30 to execute printing on a sheet P. The sheet P on which the image was printed is discharged from the image forming apparatus 30 to the inspection apparatus 50. Then, in step S506, the CPU 201 (job processing unit 206) determines whether or not printing is complete, based on the print job being executed. In other words, the CPU 201 determines whether or not printing has been completed for all pages set in the print job. If there are remaining pages to be printed, the CPU 201 returns to the processing of step S505 and controls the image forming apparatus 30 to execute printing for the next page. If there are no remaining pages to be printed, the CPU 201 ends the execution of the print job and proceeds to step S507.

In step S507, the CPU 201 (inspection control unit 205) determines whether or not an inspection result has been received from the inspection apparatus 50. If the job information (step S501) does not instruct the inspection apparatus 50 to execute an inspection job, an inspection result is not received from the inspection apparatus 50. In this case, the CPU 201 ends the processing of this procedure.

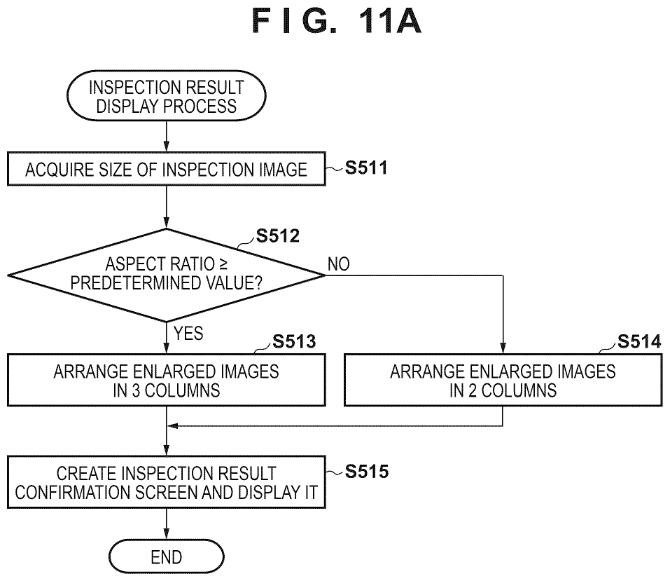

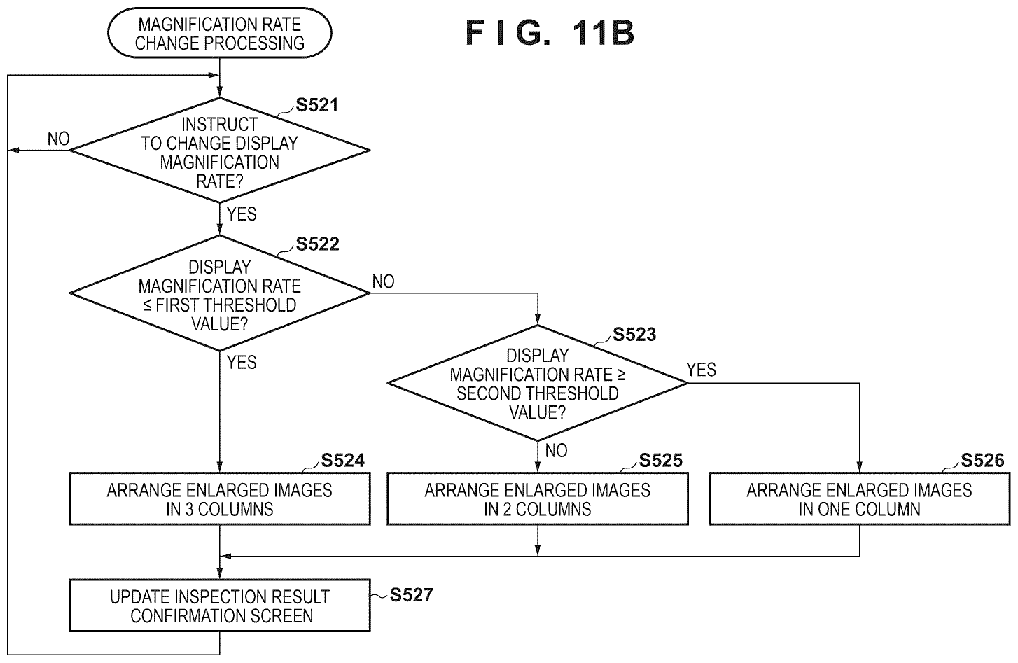

If the job information (step S501) instructs the inspection apparatus 50 to execute an inspection job, an inspection result is received from the inspection apparatus 50. In this case, the CPU 201 moves from step S507 to step S508. In step S508, the CPU 201 (inspection control unit 205) performs display processing to display the received inspection result on the display device 21. A specific example of the display processing will be described with reference to FIG. 11A. Note that a configuration is possible in which the CPU 201 displays the inspection result only when there is a sheet P that has been determined to be unacceptable. When an instruction to end the display of the inspection result is received via the operation unit 20, the CPU 201 ends the display of the inspection result and ends the processing of this procedure.

### <Processing Procedure of Inspection Apparatus 50>

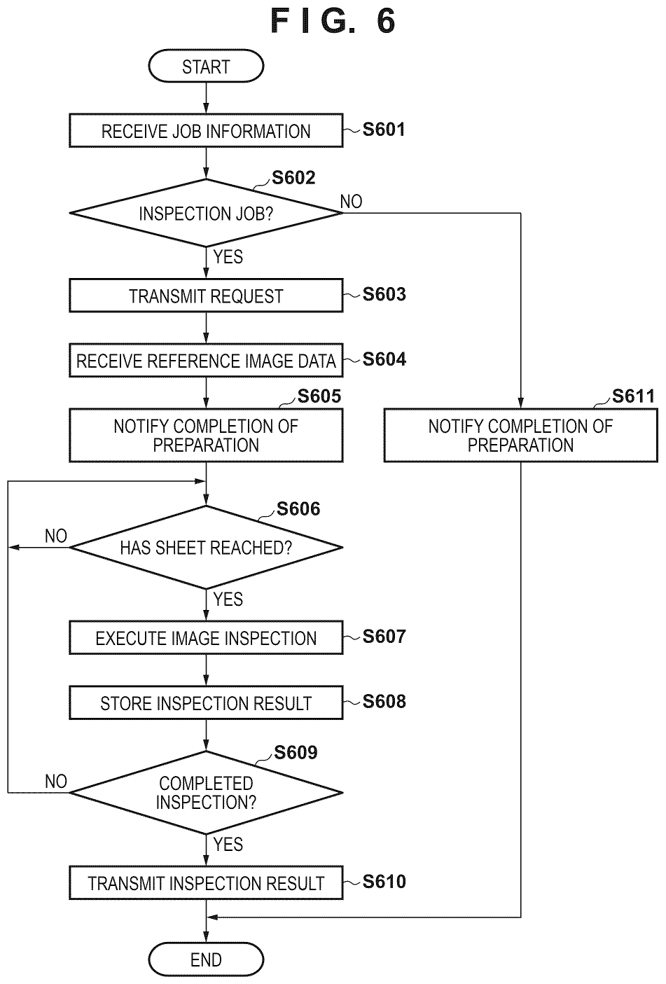

FIG. 6 is a flowchart showing an example of a procedure of processing executed by the CPU 301 of the inspection apparatus 50.

In step S601, the CPU 301 (the inspection unit 302) receives job information from the control apparatus 40. The job information may be stored in the memory 310. In the case where the job information is stored in the memory 310, the job information may be stored in the memory 310 as part of the setting data 314. Note that the CPU 301 transmits (transfers) the job information to the stacking apparatus 60a connected downstream of the inspection apparatus 50.

In step S602, the CPU 301 (inspection unit 302) analyzes the job information and determines whether or not the job information includes an instruction for executing an inspection job. If execution of an inspection job has not been instructed, the CPU 301 moves to the processing of step S611, notifies the control apparatus 40 of the completion of preparation, and ends the processing of this procedure. In this case, the inspection apparatus 50 executes a conveying job for conveying the sheet P to the downstream stacking apparatus 60a. If execution of an inspection job has been instructed, the CPU 301 moves from step S602 to step S603.

In step S603, the CPU 301 (inspection unit 302) transmits a request for the reference image data 215 to the control apparatus 40. In step S604, upon receiving the reference image data 215 from the control apparatus 40, the CPU 301 stores the received reference image data 215 in the memory 310. After that, in step S605, the CPU 301 notifies the control apparatus 40 that preparation is complete. Note that the preparation completion notification in step S605 or step S610 may also be transmitted to the downstream stacking apparatuses 60a to 60b. When the control apparatus 40 receives the notification of completion of preparation, the image forming apparatus 30 starts execution of printing on the sheet P. As a result, the sheet P starts to be discharged from the image forming apparatus 30 to the inspection apparatus 50.

In step S606, the CPU 301 (the inspection unit 302 and the conveying control unit 306) determines whether or not the sheet P has reached the inspection apparatus 50, based on the detection signal output from the sheet sensor 56. Arrival of the sheet P at the inspection apparatus 50 means that the sheet sensor 56 detects the leading edge of the sheet P. When the sheet P reaches the sheet sensor 56, the CPU 301 moves to the processing of step S607.

In step S607, the CPU 301 (the inspection unit 302 and the reading control unit 307) executes image inspection designated in accordance with the setting data 314. The reading control unit 307 generates the inspection image data 312 by reading the sheet P with the image sensors 54 and 55. Furthermore, the inspection unit 302 performs inspection on the inspection image data 312 in accordance with the inspection settings specified by the setting data 314. For example, the inspection unit 302 compares the inspection image data 312 with the reference image data 215 to determine whether or not the image formed on the sheet P meets the inspection standard.

After image inspection is executed, in step S608, the CPU 301 (inspection unit 302) stores the inspection result in the memory 310. Here, the CPU 301 (inspection unit 302) may store the inspection result in the memory 310 and also notify the inspection result to the downstream stacking apparatus 60a. In this case, the CPU 401 (flapper control unit 407) of the stacking apparatus 60 can perform control for the switching of the discharge destination of the sheet P between the PASS tray (e.g., the sheet tray 61a) and the FAIL tray (e.g., the sheet tray 62a) based on the inspection result received from the inspection apparatus 50. In other words, the CPU 401 can control the flappers F1 and F2 so as to discharge a sheet P determined to be acceptable onto the PASS tray, and discharge a sheet P determined to be unacceptable onto the FAIL tray.

Then, in step S609, the CPU 301 (inspection unit 302) determines whether or not image inspection is complete, based on the job information. If there are remaining pages to be inspected, the CPU 301 returns from step S609 to step S606 and waits for the arrival of the next sheet P. If there are no remaining pages to be inspected, the CPU 301 determines that image inspection is complete, and proceeds to step S610. In step S610, the CPU 301 (inspection unit 302) transmits the inspection result held in the memory 310 to the control apparatus 40, and ends the execution of the inspection job, thereby ending the processing of this procedure. Note that the CPU 301 transmits the inspection image data 312 to the control apparatus 40 together with the inspection result to be transmitted to the control apparatus 40.

### <Print Setting Screen>

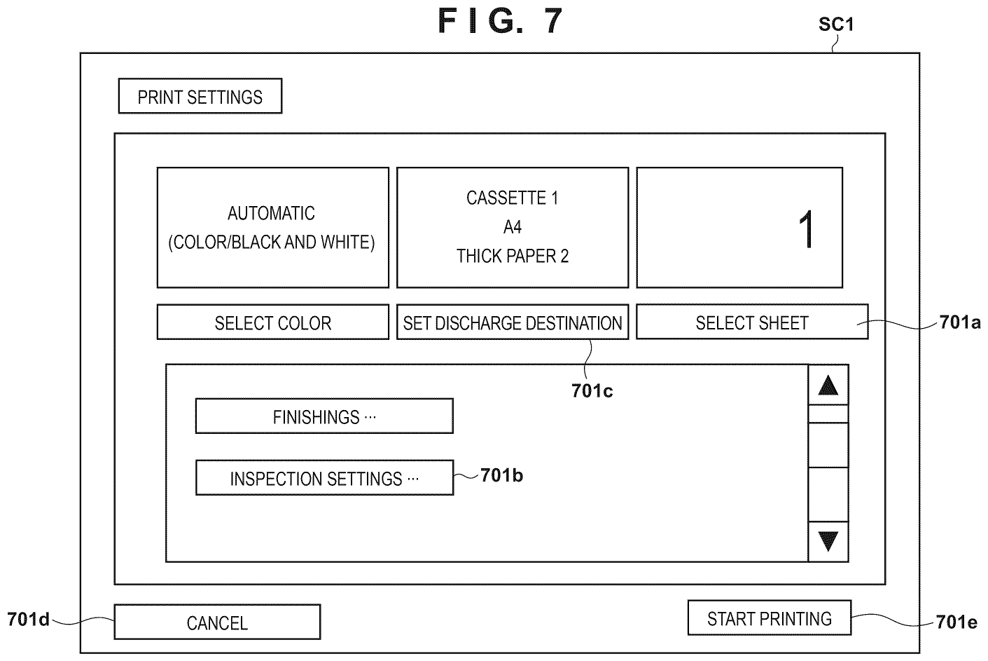

FIG. 7 shows a print setting screen SC1 as an example of the print setting screen according to the present embodiment. The print setting screen SC1 may be called a job input screen. The print setting screen SC1 is configured to receive print settings related to a print job that involves quality inspection (image inspection) to be performed on a printed material by the inspection apparatus 50. A button 701a is a button for designating the size of a sheet P to be printed (including the length of the sheet in the conveying direction), the basis weight of the sheet P, and a sheet cassette 11. A button 701b is a button for instructing a transition from the print setting screen SC1 to an inspection setting screen. In the inspection setting screen, for example, the inspection area where quality inspection is to be executed by the inspection apparatus 50 is set as an inspection setting for the quality inspection. A button 701c is a button for instructing a transition from the print setting screen SC1 to a discharge destination setting screen. In the discharge destination setting screen, for example, a discharge destination for FAIL sheets and a discharge destination for PASS sheets are set. A button 701d is a button for instructing the cancelation of setting content.

When the button 701d is pressed by an operator (user), a transition from the print setting screen SC1 to a predetermined initial screen is performed. A button 701e is a button for instructing the start of printing. When the button 701e is pressed by the operator, the CPU 201 of the control apparatus 40 starts executing processing according to the procedure of FIG. 5.

### Comparative Example

An inspection result screen (inspection result confirmation screen) displayed on the display device 21 in the inspection result display process (S508) will be described below. The following first describes an example of the inspection result screen of a comparative example, and then describes an example of the inspection result screen of the present embodiment.

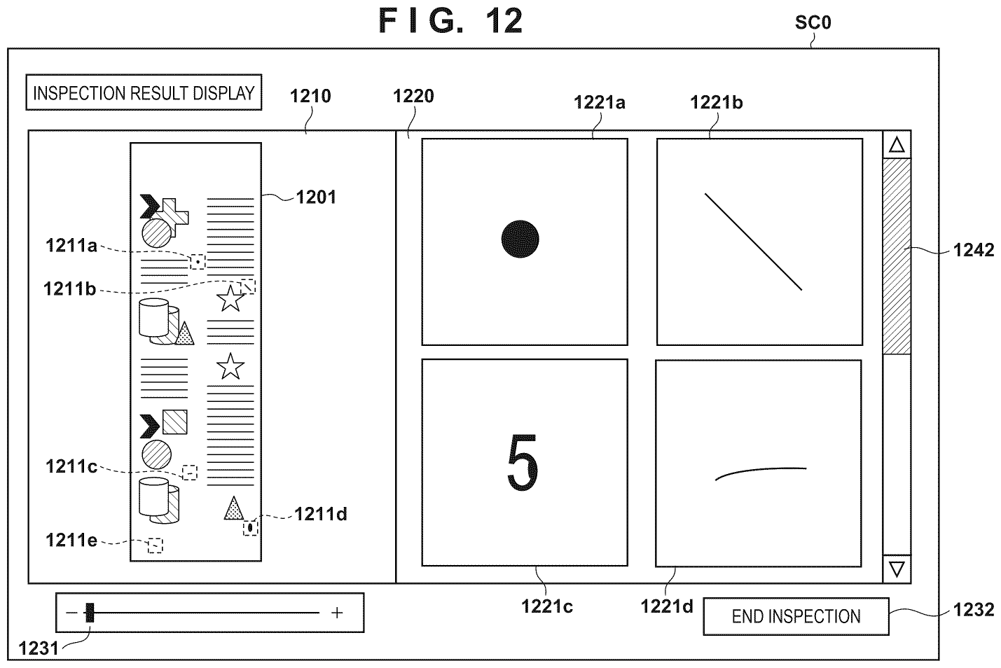

FIG. 12 shows an inspection result screen SC0 as a comparative example for comparison with the inspection result screen according to the present embodiment. The inspection result screen SC0 is an example of a screen that is displayed on the display device 21 in the case where the inspection apparatus 50 performs quality inspection on a printed material including a long-sized sheet (long paper) and the sheet is determined to be unacceptable.

The inspection result screen SC0 includes a display area 1210 used to display an inspection image on which quality inspection was performed by the inspection apparatus 50, and a display area 1220 used to display an enlarged image of a portion of the inspection image in which an abnormality (defect) has occurred. In this comparative example, the size of the display area 1210 is fixed to a predetermined size, and the size of the display area 1220 is also fixed accordingly.

In the example of FIG. 12, the entire long-sized inspection image 1201, which has been determined to be unacceptable in quality inspection, is displayed in the display area 1210, and the display size of the inspection image 1201 in the sub-scanning direction (vertical direction) is set according to the size of the display area 1210 in the vertical direction. The size of the display area 1210 is fixed, and the inspection image 1201 is an image that is long in the sub-scanning direction (vertical direction), and therefore a blank area appears in the display area 1210. The size of the blank area may be larger than when the entire inspection image is displayed on a sheet of a standard size such as the A4 size. Due to the presence of such a blank area, the area in the inspection result screen SC0 in which information related to the inspection result can be displayed is limited.

Five display items 1211a to 1211e, which indicate the positions where abnormalities have occurred in the inspection image 1201, are displayed in the display area 1210. In this way, in the example of FIG. 12, abnormalities detected at five locations in the inspection image 1201 are indicated by the display items 1211a to 1211c.

Enlarged images 1221a to 1221d displayed in display area 1220 are enlarged images of areas in the inspection image 1201 that respectively include the positions indicated by the display items 1211a to 1211d. In the example of FIG. 12, four enlarged images 1221a to 1221d respectively corresponding to four display items 1211a to 1211d are displayed in the display area 1220. The inspection result screen SC0 of this comparative example is configured such that enlarged images corresponding to abnormalities contained in the inspection image 1201 are displayed in two columns in the display area 1220. Furthermore, the maximum number of enlarged images that can be displayed in the display area 1220 is set to four.

Therefore, the four enlarged images 1221a to 1221d respectively corresponding to the four display items 1211a to 1211d are displayed in the display area 1220, and the enlarged image corresponding to the display item 1211e is not displayed. In order to display the enlarged image corresponding to the display item 1211e, a scroll bar 1242 needs to be operated. Due to the need for such an operation, it takes time and effort for the user to check the inspection result using the printed material inspection result confirmation screen, and this can result in a longer time being spent in the process from checking the inspection result to being able to resolve any abnormalities. This can also lead to increased downtime of the apparatus (image forming system).

Therefore, the image forming system 100 of the present embodiment is configured such that the size of the display area 1210 (first display area) and the size of the display area 1220 (second display area) in the inspection result screen SC0 (in the confirmation screen) are adjusted according to the size of the inspection image, rather than being set to a fixed size. Specifically, the size of the display area 1210 is adjusted so as to reduce the size of the blank area that appears when the inspection image is displayed in display area 1210 (in the first display area), and the size of the display area 1220 is increased accordingly. This allows more information regarding the inspection result (e.g., more enlarged images) to be presented to the user using the display area 1220.

### <Inspection Result Confirmation Screen>

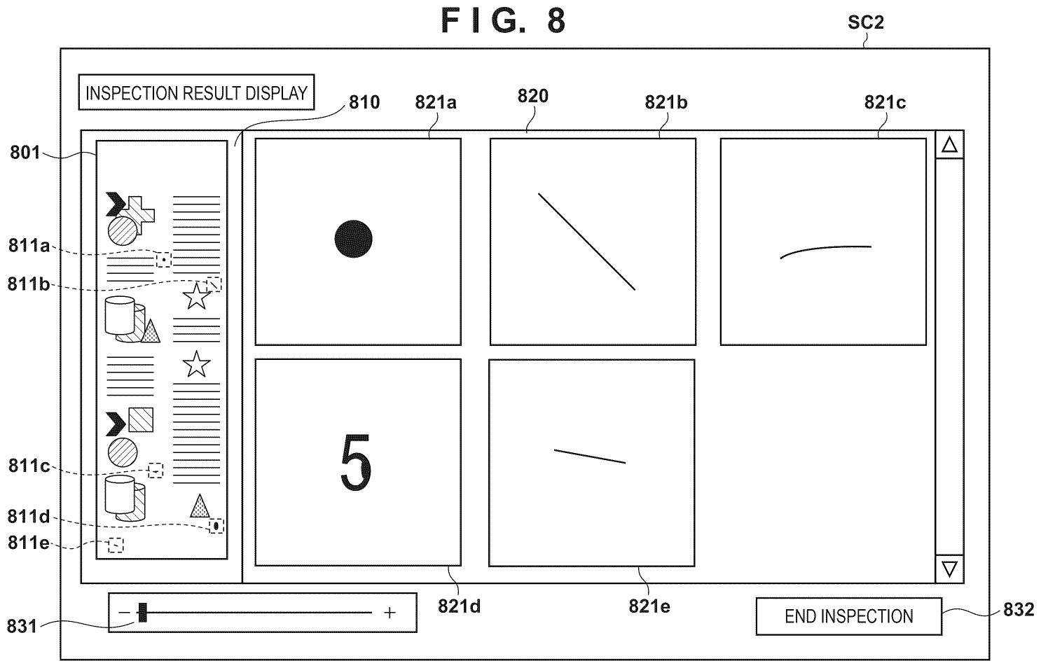

FIG. 8 shows an inspection result screen SC2 as an example of the inspection result screen (inspection result confirmation screen) according to the present embodiment. The inspection result screen SC2 is an example of a screen that is displayed in the case where quality inspection is performed on a printed material including a long-sized sheet (long paper) and the sheet is determined to be unacceptable. The inspection result screen SC2 is displayed on the display device 21 in step S508 when there is a sheet P that has been determined to be unacceptable as a result of the quality inspection performed by the inspection apparatus 50. Upon receiving the inspection result from the inspection apparatus 50, the inspection control unit 205 creates the inspection result screen SC2 based on the inspection result and causes the display device 21 to display the created screen. Note that the inspection control unit 205 generates an inspection image to be displayed in the inspection result screen SC2 based on the inspection image data 312 received from the inspection apparatus 50 together with the inspection result.

The inspection result screen SC2 includes a display area 810 used to display an inspection image on which quality inspection was performed by the inspection apparatus 50, and a display area 820 used to display an enlarged image of a portion of the inspection image in which an abnormality (defect) has occurred. The display area 810 is an example of a first display area in which, if the inspection result includes an abnormal image, an image showing the inspection result including the abnormal image is displayed. The display area 820 is an example of a second display area in which an enlarged image of an abnormal image in the inspection result is displayed. In this example, the display area 810 displays an inspection image and one or more display items (display items 811a to 811e) respectively showing one or more locations in the inspection image where an abnormality has been detected. Also, as enlarged images of abnormal images in the inspection result, one or more enlarged images obtained by enlarging areas in the inspection image including the positions respectively indicated by the one or more display items displayed in the display area 810 are displayed in the display area 820. In the inspection result screen SC2, the enlarged images in the display area 820 (second display area) are displayed in multiple columns extending in the vertical direction of the inspection result screen.

The sizes of the display area 810 and the display area 820 in the inspection result screen SC2 can be changed, and are adjusted according to the size of the inspection image corresponding to the inspection image data 312. For example, the ratio between the size of the display area 810 and the size of the display area 820 may be adjusted according to the size of the inspection image.

In the example of FIG. 8, a long-sized inspection image 801 (an image corresponding to the inspection image data 312) that has been determined to be unacceptable in the quality inspection is displayed in its entirety in the display area 810. At this time, the size (vertical size and horizontal size) of the display area 810 is set so as to reduce the size of the blank area (where the inspection image 801 is not displayed) in the display area 810. At this time, the size of the display area 810 (first display area) is changed as follows, for example. When a sheet having a first length in the conveying direction has been read, the size of the display area 810 is a first size, and when a sheet having a second length in the conveying direction has been read, the size of the first display area is a second size. In this case, the first length is longer than the second length, and the first size is smaller than the second size. As a result, in the inspection result screen SC2, the size of the display area 810 is adjusted (reduced) such that the size of the blank areas is smaller than in the display area 1100 in the inspection result screen SC0 (FIG. 12) of the comparative example.

As one example, the vertical size of the display area 810 may be fixed, and the display size of the inspection image 801 in the sub-scanning direction (vertical direction) may be set according to the vertical size of the display area 810. Furthermore, the horizontal size of the display area 810 may be adjusted according to the size of the inspection image 801 in the main scanning direction (horizontal direction) in that case.

Five display items 811a to 811e are displayed in the display area 810 as one or more display items respectively indicating one or more positions in the inspection image 801 where an abnormality has been detected. Thus, in the example of FIG. 8, the fact that abnormalities (first to fifth abnormalities) have been detected at five positions in the inspection image 801 is indicated by the display items 811a to 811c.

Enlarged images 821a to 821e displayed in the display area 820 are enlarged images of areas in the inspection image 801 that include the positions indicated by the display items 811a to 811e, respectively. Note that the enlarged images 821a to 821c have the same size. In the example of FIG. 8, five enlarged images 821a to 821d respectively corresponding to the five display items 811a to 811d are displayed in the display area 820.

The size of the display area 820 in the inspection result screen SC2 in the present embodiment is adjusted according to the size of the display area 810 (the size of the inspection image 801 displayed in the display area 810). Specifically, the display area 820 of the inspection result screen SC2 is larger in the horizontal direction than the display area 1220 of the inspection result screen SC0 (FIG. 12) of the comparative example. As a result, the inspection result screen SC2 of the present embodiment is configured such that enlarged images corresponding to abnormalities contained in the inspection image 801 are displayed in three columns in the display area 820 (compared to being displayed in two columns in the inspection result screen SC0 of the comparative example). Furthermore, the maximum number of enlarged images that can be displayed in the display area 820 is set to six, which is increased from four in the inspection result screen SC0 of the comparative example.

In this way, the inspection result screen SC2 of the present embodiment is capable of presenting the user with more enlarged images (i.e., more information regarding the inspection result) corresponding to abnormalities included in the inspection image 801, compared to the inspection result screen SC0 of the comparative example. This makes it possible to reduce the time and effort required for the user to check the inspection result using the printed material inspection result confirmation screen.

The inspection result screen SC2 further includes a magnification rate change bar 831 and a button 832. The magnification rate change bar 831 is used to change the display magnification rate (enlargement ratio) of the inspection image displayed in the display area 810. The inspection control unit 205 performs display control on the inspection result screen SC2 such that the display magnification rate (enlargement ratio) of the inspection image displayed in the display area 810 is changed in accordance with operations performed on the magnification rate change bar 831. The button 832 is a button for ending the printed material quality inspection. If the user presses the button 832 after checking the inspection result using the inspection result screen SC2, the inspection control unit 205 ends the printed material quality inspection.

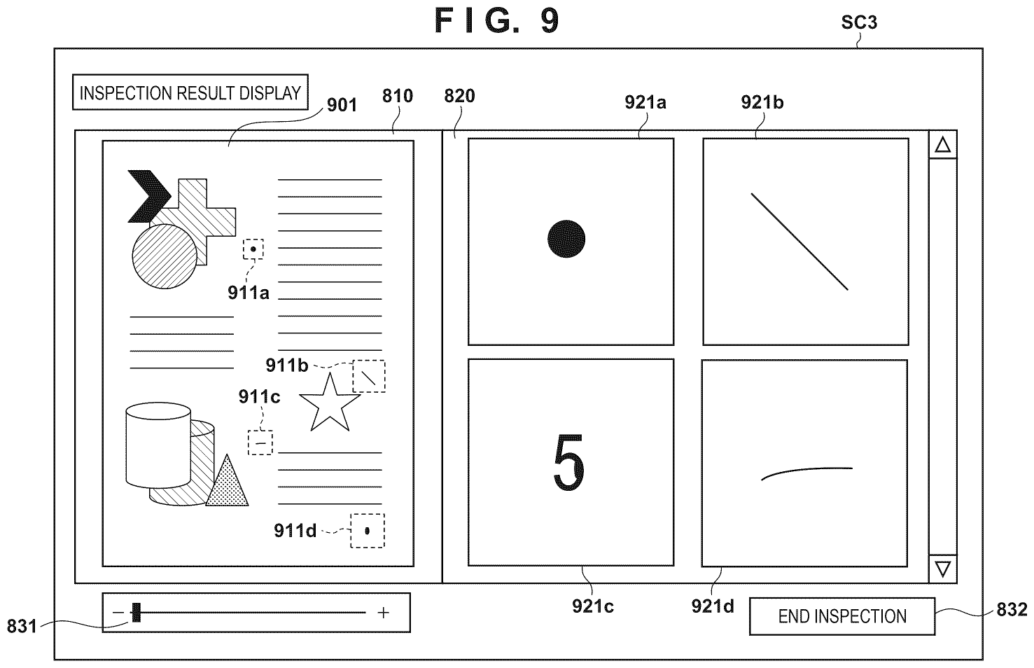

FIG. 9 shows an inspection result screen SC3 as an example of the inspection result screen (inspection result confirmation screen) according to the present embodiment. The inspection result screen SC3 is an example of a screen that is displayed in the case where quality inspection is performed on a printed material including an A4-sized sheet and the sheet is determined to be unacceptable. In the case where there is a sheet P that has been determined to be unacceptable as a result of the quality inspection performed by the inspection apparatus 50, the inspection result screen SC3 is displayed on the display device 21 in step S508. Upon receiving the inspection result from the inspection apparatus 50, the inspection control unit 205 creates the inspection result screen SC3 based on the inspection result and causes the display device 21 to display the created screen.

In the example of FIG. 9, an A4-sized inspection image 901 (an image corresponding to the inspection image data 312) that has been determined to be unacceptable in the quality inspection is displayed in its entirety in the display area 810 of the inspection result screen SC3. The display area 810 displays display items 911a to 911d indicating positions where abnormalities (first to fourth abnormalities) have occurred in the inspection image 901. Also, four enlarged images 921a to 921d respectively corresponding to the four display items 911a to 911d are displayed in the display area 820.

When the inspection result screen SC2 is compared with the inspection result screen SC3, it can be seen that the sizes of the display areas 810 and 820 have been adjusted according to the sizes of the inspection images (inspection images 801 and 901). Specifically, in the inspection result screen SC3, the horizontal size of the display area 820 has been set such that the enlarged images 921a to 921d are arranged in two columns in accordance with the A4-sized (standard size) inspection image 901. On the other hand, in the inspection result screen SC2, the display area 820 has been enlarged horizontally such that the enlarged images 821a to 821e are arranged in three columns, in accordance with the long-sized inspection image 801. In this way, the maximum number of enlarged images that can be displayed in the display area 820 can be changed according to the size of the inspection image.

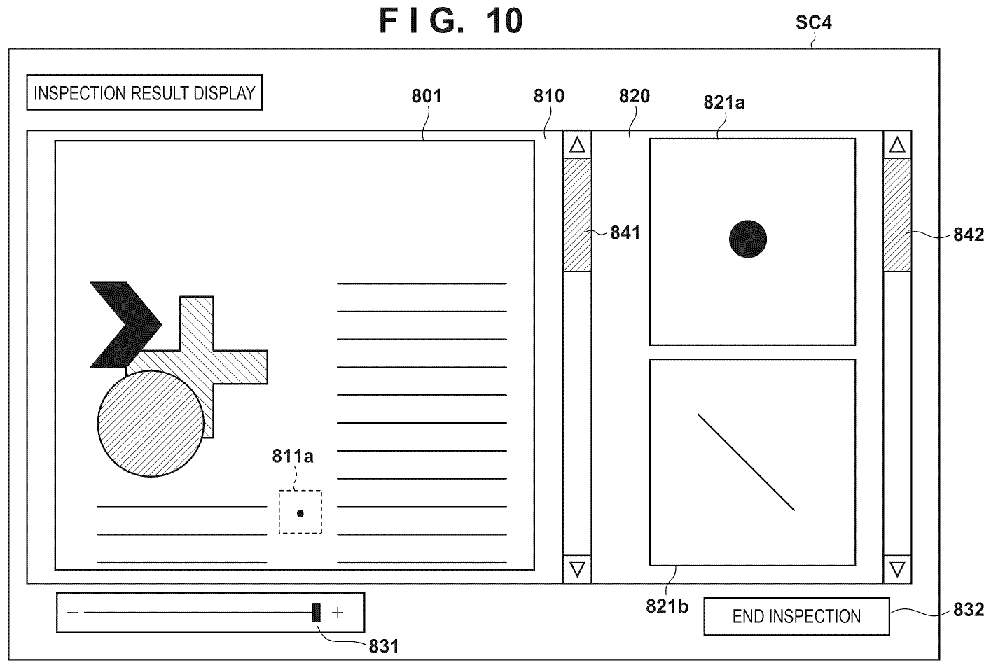

FIG. 10 shows an inspection result screen SC4 as an example of an inspection result screen (inspection result confirmation screen) in the case where a change in the display magnification rate (enlargement ratio) of the inspection image 801 has been instructed using the magnification rate change bar 831 on the inspection result screen SC2. In this example, when the display magnification rate is changed to the maximum magnification using the magnification rate change bar 831 in the inspection result screen SC2, the inspection result screen SC2 transitions to the inspection result screen SC4.

In the inspection result screen SC4, scroll bars 841 and 842 are newly displayed in accordance with the change to the display magnification rate of the inspection image 801. Only a part of the inspection image 801 is displayed in the display area 810 in the inspection result screen SC4. The scroll bar 841 is used to move the inspection image 801 displayed in the display area 810 parallel to the sub-scanning direction (vertical direction) such that a portion of the overall inspection image 801 that is not displayed in the display area 810 is displayed in the display area 810.

The enlarged images 821a and 821b are displayed in the display area 820 of the inspection result screen SC4. The enlarged image 821a corresponds to the display item 811a indicating the location where the first abnormality occurred. The enlarged image 821b corresponds to the display item 811b (FIG. 8) that indicates the location where the second abnormality occurred, and is not currently displayed in the display area 810 but can be made visible by operating scroll bar 841.

When the inspection result screen SC2 is compared with the inspection result screen SC4, it can be seen that the sizes of the display areas 810 and 820 have been adjusted in accordance with the change to the display magnification rate of the inspection image 801. In this example, the display magnification rate of the inspection image 801 on the inspection result screen SC2 is set to 100%, and when the display magnification rate is less than or equal to a first threshold value (e.g., 150%), the display area 820 is set such that the enlarged images 821 are arranged in three columns, as in the inspection result screen SC2. Furthermore, when the display magnification rate of the inspection image 801 is greater than or equal to a second threshold value (e.g., 300%) that is greater than the first threshold value, the display area 820 is set such that the enlarged images 821 are arranged in a single column, as in the inspection result screen SC4. In other cases (when the display magnification rate of the inspection image 801 is greater than the first threshold value and less than the second threshold value), the display area 820 is set such that the enlarged images 821 are arranged in two columns. Note that instead of such display control, control may be performed such that the ratio between the size of the display area 810 and the size of the display area 820 is linearly changed in accordance with (in conjunction with) the display magnification rate of the inspection image 801.

In the present embodiment, when a change to the display magnification rate of the inspection image 801 is instructed (using the scroll bar 841), the ratio of the sizes of the display area 810 (first display area) and the display area 820 (second display area) in the inspection result confirmation screen is changed in accordance with the change to the display magnification rate. At this time, the size of the display area 810 (first display area) is changed as follows, for example. When an image is displayed in the display area 810 at a first enlargement ratio, the size of the display area 810 is a first size, and when an image is displayed in the display area 810 at a second enlargement ratio, the size of the display area 810 is a second size. In this case, the first enlargement ratio is smaller than the second enlargement ratio, and the first size is smaller than the second size. By changing the ratio between the size of the display area 810 and the size of the display area 820 on the inspection result screen in accordance with the display magnification rate of inspection image 801, information related to the inspection result can be appropriately presented to the user. This makes it easier for the user to check the inspection result using the inspection result confirmation screens (e.g., the inspection result screens SC2 and SC4).

### <Example of Procedure of Display Processing (S508)>

Such adjustment of the sizes of the display areas 810 and 820 on the inspection result confirmation screen (FIGS. 8 to 10) may be performed, for example, as follows. FIG. 11A is a flowchart showing an example of a procedure of inspection result display processing executed by the CPU 201 (inspection control unit 205) in step S508.

In step S511, the CPU 201 acquires the size of the inspection image on which quality inspection was performed by the inspection apparatus 50. In this example, the CPU 201 adjusts the size of the first display area (display area 810) and the size of the second display area (display area 820) in the inspection result confirmation screen in accordance with the size ratio of the lengthwise size to the widthwise size (aspect ratio) of the inspection image. For example, when the aspect ratio of the inspection image is a threshold value or more (a predetermined value or more), as with a long-sized inspection image, the CPU 201 adjusts the size of the first display area and the size of the second display area such that more enlarged images are displayed than when the aspect ratio is not the threshold value or more.

Specifically, in step S512, the CPU 201 determines whether or not the aspect ratio of the inspection image is a predetermined value or more. The predetermined value is set to 4, for example. If the aspect ratio of the inspection image is the predetermined value or more (e.g., if the inspection image is a long-size image), the CPU 201 moves to the processing of step S513. In step S513, the CPU 201 adjusts the size of the first display area and the size of the second display area in the inspection result confirmation screen such that one or more enlarged images each corresponding to an abnormality included in the inspection image are arranged in three columns, as in the inspection result screen SC2.

If the aspect ratio of the inspection image is not the predetermined value or more (e.g., if the inspection image is an A4 size image), the CPU 201 moves from S512 to S514. In step S514, the CPU 201 adjusts the size of the first display area and the size of the second display area in the inspection result confirmation screen such that one or more enlarged images each corresponding to an abnormality included in the inspection image are arranged in two columns, as in the inspection result screen SC3.

Thus, in this example, the CPU 201 adjusts the size of the first display area and the size of the second display area such that when the size ratio (aspect ratio) of the inspection image is a threshold value or more, the number of columns in which one or more enlarged images are arranged is greater than when the size ratio is not the threshold value or more. Thereafter, in step S515, the CPU 201 creates an inspection result confirmation screen (result confirmation screen SC2 or SC3) in accordance with the adjustment result in step S513 or S514, and causes the display device 21 to display the created screen.

FIG. 11B is a flowchart showing an example of a procedure of magnification rate change processing executed by the CPU 201 (inspection control unit 205) while the inspection result confirmation screen is displayed.

In step S521, the CPU 201 determines whether or not a change to the display magnification rate of the inspection image displayed in the first display area (display area 810) has been instructed via the inspection result confirmation screen (e.g., result confirmation screen SC or SC3) displayed on the display device 21. If an instruction to change the display magnification rate of the inspection image has been accepted via the inspection result confirmation screen, the CPU 201 moves to step S522.

If the changed display magnification rate is the first threshold value or less (e.g., 150%), the CPU 201 moves from step S522 to step S524. In step S524, the CPU 201 adjusts the size of the first display area and the size of the second display area in the inspection result confirmation screen such that one or more enlarged images each corresponding to an abnormality included in the inspection image are arranged in three columns.

If the changed display magnification rate is not the first threshold value or less (e.g., 150%), the CPU 201 moves from step S522 to step S523. Furthermore, if the changed display magnification rate is the second threshold value or more (e.g., 300%), the CPU 201 moves from step S523 to step S526. In step S526, the size of the first display area and the size of the second display area in the inspection result confirmation screen are adjusted such that one or more enlarged images each corresponding to an abnormality included in the inspection image are arranged in one column.

If the changed display magnification rate is higher than the first threshold value (e.g., 150%) but lower than the second threshold value (e.g., 300%) (NO in step S523), the CPU 201 moves from step S523 to step S525. In step S525, the size of the first display area and the size of the second display area in the inspection result confirmation screen are adjusted such that one or more enlarged images each corresponding to an abnormality included in the inspection image are arranged in two columns. Thus, in this example, when an increase in the display magnification rate is instructed, the ratio between the size of the first display area and the size of the second display area in the inspection result confirmation screen is changed so as to reduce the number of enlarged images displayed in the second display area.

Thereafter, in step S527, the CPU 201 updates the inspection result confirmation screen displayed on the display device 21 in accordance with the adjustment result of step S524, S525, or S526, and then returns to step S521.

As described above, in the image forming system 100 of the present embodiment, the image forming apparatus 30 forms an image on a sheet. The inspection apparatus 50 performs inspection on the printed material, which includes the sheet and the image formed on the sheet by the image forming apparatus 30, based on an inspection image obtained by reading the printed material. In the case where an abnormal image is present in the inspection result obtained by the inspection apparatus 50, the control apparatus 40 displays a screen including a first display area in which an image showing the inspection result including the abnormal image is displayed, and a second display area in which an enlarged image of the abnormal image in the inspection result is displayed. When displaying the confirmation screen, the control apparatus 40 adjusts the size of the first display area and the size of the second display area in the confirmation screen in accordance with the size of the inspection image.

As a result, more information (e.g., more enlarged images) regarding the printed material inspection result obtained by the inspection apparatus 50 can be presented to the user using the second display area (display area 820) of the confirmation screen. Therefore, according to the present embodiment, in the image forming system 100 including the inspection apparatus 50, it is possible to make it easier for the inspection result to be checked by the user.

In the present embodiment, when the size ratio of the first display area and the second display area in the inspection result confirmation screen is changed, the number of columns in which enlarged images are arranged in the second display area is changed, but instead, the display size of the enlarged images may be changed (e.g., made smaller). Accordingly, the number of enlarged images displayed in the second display area can be changed.

In the present embodiment, the display control of the inspection result screen SC2 in the image forming system 100 is performed by the CPU 201 (inspection control unit 205) of the control apparatus 40, such display control may be performed by the inspection apparatus 50. In other words, the CPU 301 (inspection unit 302) of the inspection apparatus 50 may function as a display control unit. In this case, the inspection apparatus 50 may be provided with an input device and a display device (display), or the operation unit 20 (display device 21 and input device 22) of the image forming system 100 may be used by the CPU 301 (setting unit 303).

According to the present disclosure, in an image forming system including an inspection apparatus, an inspection result can be more easily checked by a user.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-135033, filed Aug. 13, 2024, which is hereby incorporated by reference herein in its entirety.

What is claimed is:

1. An inspection apparatus that performs inspection on an image formed on a sheet, based on an inspection image obtained by reading the sheet, the inspection apparatus comprising:
a display unit; and
a control unit configured to, in a case where an abnormal image is included in an inspection result, display, on the display unit, a confirmation screen including a first display area in which an image showing the inspection result including the abnormal image is displayed, and a second display area in which an enlarged image of the abnormal image in the inspection result is displayed,
wherein the control unit adjusts a size of the first display area and a size of the second display area in the confirmation screen in accordance with a size of the inspection image.

2. The inspection apparatus according to claim 1,
wherein the inspection image is displayed in the first display area along with one or more display items respectively showing one or more positions at which an abnormality has been detected in the inspection image, and
one or more enlarged images of one or more areas including the one or more positions shown by the one or more display items in the inspection image are displayed in the second display area.

3. The inspection apparatus according to claim 1,
wherein the control unit adjusts a ratio of the size of the first display area and the size of the second display area in accordance with the size of the inspection image.

4. The inspection apparatus according to claim 1,
wherein the control unit adjusts the size of the first display area in accordance with the size of the inspection image, and adjusts the size of the second display area in accordance with the size of the first display area.

5. The inspection apparatus according to claim 4,
wherein the control unit adjusts the size of the first display area such that fewer blank areas are displayed in the first display area when the inspection image is displayed in the first display area.

6. The inspection apparatus according to claim 2,
wherein the one or more enlarged images each have the same size, and
the control unit adjusts the size of the first display area and the size of the second display area such that in a case where a size ratio of a lengthwise size of the inspection image to a widthwise size of the inspection image is a threshold value or more, more enlarged images are displayed than in a case where the size ratio is not the threshold value or more.

7. The inspection apparatus according to claim 6,
wherein the control unit displays the one or more enlarged images in the second display area in a plurality of columns extending in a vertical direction of the confirmation screen, and
the control unit adjusts the size of the first display area and the size of the second display area such that in a case where the size ratio is the threshold value or more, the one or more enlarged images are arranged in more columns than in a case where the size ratio is not the threshold value or more.

8. The inspection apparatus according to claim 7,
wherein the control unit adjusts the size of the first display area and the size of the second display area such that the one or more enlarged images are arranged in two columns in the second display area in a case where the size ratio is not the threshold value or more, and such that the one or more enlarged images are arranged in three columns in the second display area in a case where the size ratio is the threshold value or more.

9. The inspection apparatus according to claim 2,
wherein the control unit is further configured to, in a case where a change to an enlargement ratio of the inspection image displayed in the first display area is instructed via the confirmation screen, change a ratio of the size of the first display area and the size of the second display area in the confirmation screen in accordance with the change to the enlargement ratio.

10. The inspection apparatus according to claim 9,
wherein in a case where an increase in the enlargement ratio is instructed via the confirmation screen, the control unit changes the ratio of the size of the first display area and the size of the second display area in the confirmation screen such that fewer of the enlarged images are displayed in the second display area.

11. The inspection apparatus according to claim 1, further comprising:
an acquisition unit configured to acquire inspection image data by reading a sheet conveyed from the image forming apparatus; and
an inspection unit configured to perform inspection on an image formed on the sheet, based on the inspection image data and reference image data serving as a reference for the inspection.

12. The inspection apparatus according to claim 11,
wherein the reference image data is input image data used in image formation performed by the image forming apparatus.

13. The inspection apparatus according to claim 1,
wherein in a case of reading a sheet whose length in a conveying direction is a first length, the size of the first display area is a first size,
in a case of reading a sheet whose length in the conveying direction is a second length, the size of the first display area is a second size,
the first length is longer than the second length, and
the first size is smaller than the second size.

14. The inspection apparatus according to claim 1,
wherein in a case where an image is displayed in the first display area with a first enlargement ratio, the size of the first display area is a first size,
in a case where an image is displayed in the first display area with a second enlargement ratio, the size of the first display area is a second size,
the first enlargement ratio is smaller than the second enlargement ratio, and the first size is smaller than the second size.

15. The inspection apparatus according to claim 13,
wherein the inspection image is displayed in the first display area along with one or more display items respectively showing one or more positions at which an abnormality has been detected in the inspection image, and
one or more enlarged images of one or more areas including the one or more positions shown by the one or more display items in the inspection image are displayed in the second display area.

16. The inspection apparatus according to claim 15,
wherein the one or more enlarged images each have the same size, and
the control unit adjusts the size of the first display area and the size of the second display area such that in a case where a size ratio of a lengthwise size of the inspection image to a widthwise size of the inspection image is a threshold value or more, more enlarged images are displayed than in a case where the size ratio is not the threshold value or more.

17. The inspection apparatus according to claim 15,
wherein the control unit is further configured to, in a case where a change to an enlargement ratio of the inspection image displayed in the first display area is instructed via the confirmation screen, change a ratio of the size of the first display area and the size of the second display area in the confirmation screen in accordance with the change to the enlargement ratio.

18. The inspection apparatus according to claim 14,
wherein the inspection image is displayed in the first display area along with one or more display items respectively showing one or more positions at which an abnormality has been detected in the inspection image, and
one or more enlarged images of one or more areas including the one or more positions shown by the one or more display items in the inspection image are displayed in the second display area.

19. The inspection apparatus according to claim 18,
wherein the one or more enlarged images each have the same size, and
the control unit adjusts the size of the first display area and the size of the second display area such that in a case where a size ratio of a lengthwise size of the inspection image to a widthwise size of the inspection image is a threshold value or more, more enlarged images are displayed than in a case where the size ratio is not the threshold value or more.

20. The inspection apparatus according to claim 18,
wherein the control unit is further configured to, in a case where a change to an enlargement ratio of the inspection image displayed in the first display area is instructed via the confirmation screen, change a ratio of the size of the first display area and the size of the second display area in the confirmation screen in accordance with the change to the enlargement ratio.
